(19) United States
(12) Patent Application Publication
(10) Pub. No.: US 2013/0152766 A1
(43) Pub. Date: Jun. 20, 2013

(54) CORD RETAINER DEVICE AND METHOD

(71) Applicants: Jean C. Perrault, San Marcos, CA (US); Prisca J. Perrault, Carlsbad, CA (US)

(72) Inventors: Jean C. Perrault, San Marcos, CA (US); Prisca J. Perrault, Carlsbad, CA (US)

(21) Appl. No.: 13/684,133

(22) Filed: Nov. 21, 2012

Related U.S. Application Data
(60) Provisional application No. 61/629,662, filed on Nov. 23, 2011.

(51) Int. Cl. G10G 7/00

(52) U.S. Cl. CPC G10G 7/00
USPC 84/453

(57) ABSTRACT

A cord retaining device includes a decorative retainer member having a gripper for attaching removably to a musical instrument cord. The cord retainer device helps maintain the cord connected to the musical instrument.

### RELATED APPLICATION

The present patent application claims priority to U.S. provisional patent application, Ser. No. 61/629,662, filed Nov. 23, 2011, and entitled Code Retainer Device and Method. This provisional patent application Ser. No. 61/629,662 is hereby incorporated by references as if fully set forth herein.

### FIELD OF THE INVENTION

The present invention relates in general to a cord retainer device and method, and it more particularly relates to a cord retainer device for use with musical instruments such as guitars, to prevent or at least inhibit greatly the disconnecting or dislodging inadvertently an electrical cord or the like from the guitar during the playing of it.

### BACKGROUND ART

This section describes the background art of the disclosed embodiment of the present invention. There is no intention, either express or implied, that the background art discussed in this section legally constitutes prior art.

Musicians who play musical instruments such as electric guitars often times experience the problem of the electrical cord being dislodged inadvertently from the output jack of the guitar while performing. This can happen when the performer is moving his or her instrument while playing it, or accidentally steps on the electrical cord while playing the instrument. One unsatisfactory approach in attempting to overcome this problem is to extend the electrical cord between the guitar and a conventional strap used to enable the guitar to be worn by the user.

### BRIEF DESCRIPTION OF THE DRAWINGS

In order to better understand the invention and to see how the same may be carried out in practice, non-limiting preferred embodiments will now be described with reference to the accompanying drawings, in which:

FIG. 1 is a pictorial view of a cord retainer device, which is constructed in accordance with an embodiment, and which is illustrated attached to a musical instrument being played by a user;

FIG. 2 is an enlarged view of the cord retainer device of FIG. 1;

FIG. 3 is an enlarged elevational view of the cord retainer device of FIG. 1, illustrating it detached from the musical instrument;

FIG. 4 is a elevational view of another cord retainer device, illustrating it attached to a guitar strap, only one end portion of which being shown in the drawings;

FIG. 5 is a pictorial view of another guitar strap for attachment to a cord retainer device according to another embodiment;

FIGS. 6-9 are elevational views of other embodiments of cord retainer devices according to further embodiments, the devices being illustrated without their guitar connector;

FIGS. 10-12 are respective front, rear and side views of other embodiments of cord retainer devices, which are constructed according to still further embodiments and which are illustrated without their guitar connector;

FIGS. 13-15 are respective front, rear and side views of yet another cord retainer device, which is yet another embodiment of the invention;

FIGS. 16 and 17 are respective rear and side views of the device of FIGS. 13-15, illustrating it in its open opposition for receiving an electrical cord;

FIGS. 18-20 are face views of a further cord container device, which is a further embodiment;

FIGS. 21-22 are face views of the components of the device of FIGS. 18-20;

FIG. 23 is a sectional view of the device of FIGS. 18-20; and

FIG. 24 is a sectional view of the component of FIG. 22.

### CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of certain ones of the embodiments of the system, components and method, as represented in the drawings, is not intended to limit the scope of the invention, as claimed, but is merely representative of the embodiment of the invention.

According to an embodiment of the present invention, there is provided a cord retainer device for musical instruments such as a guitar having a cord such as electric cord to help maintain the cord connected to the musical instrument. The device includes a decorative retainer member having a gripper for attaching removably to the musical instrument cord. A musical instrument connector attaches the decorative member to the musical instrument.

According to other embodiments, a musical instrument strap is provided for helping support the instrument from the user and includes an extension for attaching to the cord retainer device.

According to a further embodiment, the method of retaining an electrical cord to a musical instrument using the cord retaining device is disclosed.

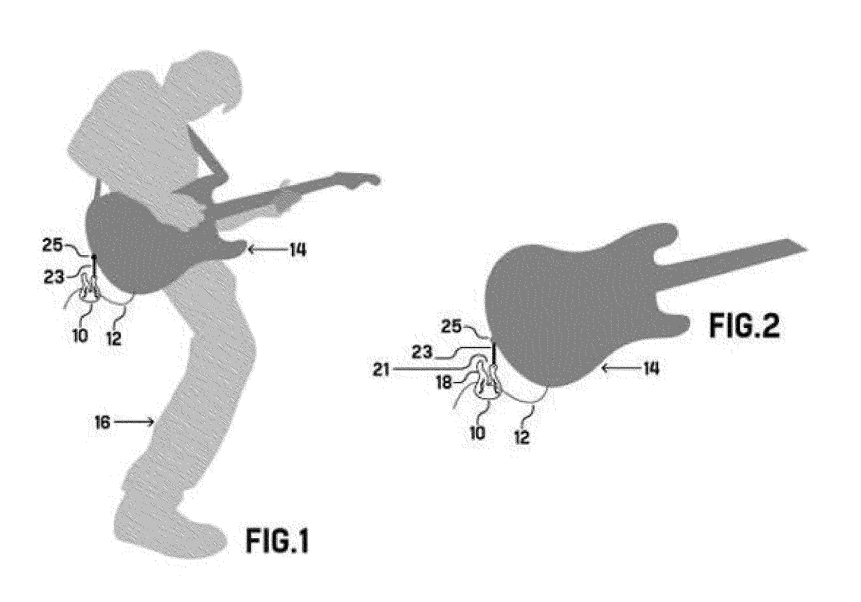

Referring now to the drawings, and more particularly to FIGS. 1-3 thereof, there is shown a cord retainer device 10 which may be constructed in accordance with an embodiment, and which is able to be attached to a cord such as an electrical cord 12 of a musical instrument such as a guitar 14 being played by a user 16. The device 10 prevents or at least greatly inhibits the dislodging inadvertently of the end of the cord 12 from a conventional output jack (not shown) of the guitar 14 during the playing of the guitar 14 when the user 16 is moving about during his or her performance.

Considering now the decorative retainer device 10 in greater detail, the device 10 includes a decorative retainer member in the form of a plate 18. The plate 18 includes a cord gripper in the form of an open curved slot 21 for receiving removably the cord 12. When the cord 12 is engaged within the slot 21, the device 10 provides a locking tension between the jack end of the cord 12 and any tension applied at the other end or portion of the cord tending to dislodge the cord jack end from its output jack. A plate connector 23 connects the plate 18 to an end pin 25 of the guitar 14 as best seen in FIGS. 1 and 2 of the drawings. As best seen in FIG. 3 of the drawings, the plate connector 23 may be a decorative strand 27, which may be a decorative chain having decorative elements thereon. One end of the strand 27 may include an attachment ring 29 which is adapted to be secured to a guitar attachment point such as the end pin 25, a strap knob, a strap button or other, on the guitar 14. The plate connector 23 is currently preferably an elongated flexible line which permits the decorative plate 18 to dangle moveably from the musical instrument while it is being played, and yet resists tension forces applied to the electrical cord 12.

The plate 18 may have various different decorative shapes such as the shape of a guitar as shown in the drawings. Also, there may be artistic cut-out openings in the plate, such as the artistic or decorative cut-outs as shown in the drawings. The plate 18 may be thin and flat, and be designed in different colors and finishes.

The curved slot 21 is generally S-shaped and is an open slot or opening in the plate 18. The curved slot 21 has a large open entrance end to receive the electrical cord 12, and terminates at its opposite closed end at or near the central portion of the plate 18.

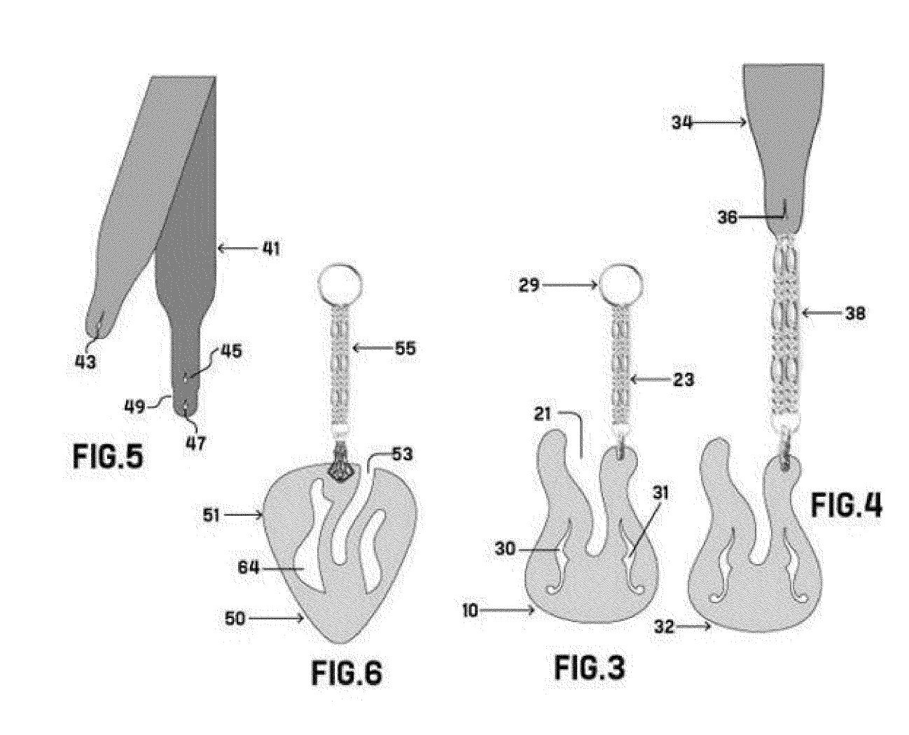

Referring now to FIG. 4, there is shown another cord retainer device 32, which is constructed in accordance with another embodiment. The device 32 may be attached to a conventional musical instrument strap 34 having an opening 36 in an end of the strap 34 to enable a connector such as a strand 38, to be secured at the end of a decorative strand 38 which is connected at its opposite end to the device 32. The device 32 is similar to the device 10.

Referring to FIG. 5, there is shown another musical instrument strap 41 which is constructed in accordance with a further embodiment to secure a cord retaining device such as a device 10 thereto. Strap 41 is similar to the strap 34, except the strap 41 includes an additional hole for attachment to a decorative device. The strap 41 includes a pair of strap holes 43 and 45 for supporting on the user the musical instrument such as the guitar 14 in a conventional manner. An additional opening or hole 47 of an extension 49 of the strap 41 is adapted to secure one end of a strand such as the strand 23 of a cord retainer device such as the device 10 of a musical instrument such as the guitar 14.

Referring now to FIG. 6, there is shown a cord retainer device 50, which is constructed in accordance with an embodiment. The device 50 is similar to the device 10 and includes a cord gripper in the form of a narrow curved slot 53, and which is similar to the curved slot 21 except that it is generally the same with throughout its curved length. A connector 55 is similar to the connector 23. The device 50 includes decorative or ornamental openings such as the opening 64. The device 50 functions in a similar manner as the device 10, except that the device 50 has a somewhat different aesthetic appearance as the device 10. The device 50, which includes the curved opening 53 has a teardrop shape.

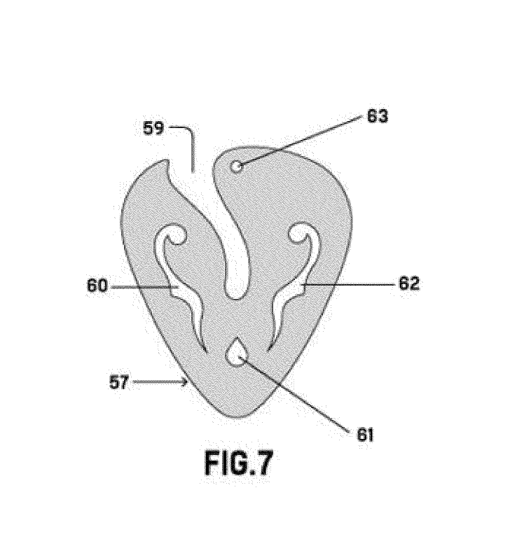

Considering now a cord retainer device 57 as shown in FIG. 7, the device 57 is constructed in accordance with an embodiment and has a somewhat different aesthetic appearance. The device 57 includes a gripper in the form of a curved slot 59. Also, there are several decorative openings 60, 61 and 62, which provide a distinctive ornamental design for the device 50.

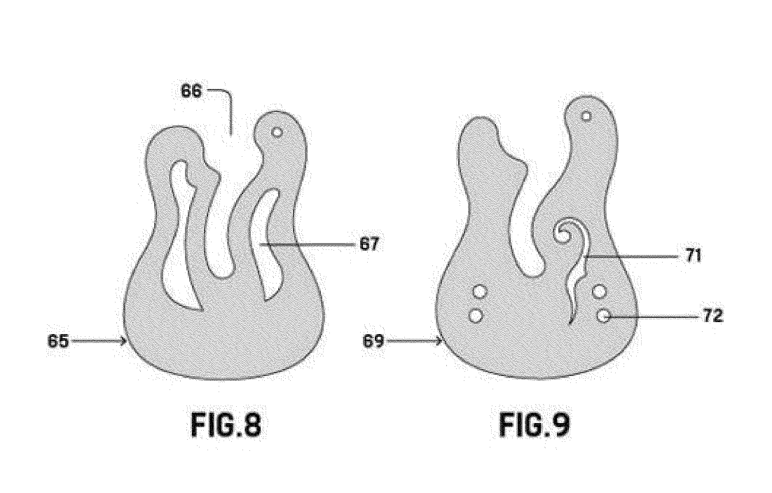

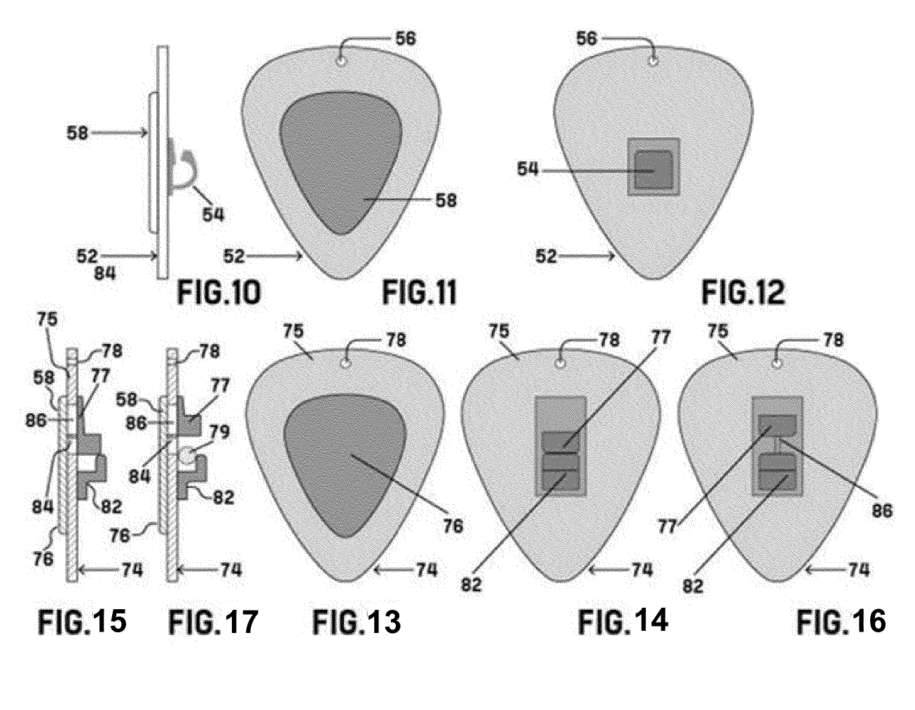

Referring now to FIG. 8, there is shown a cord retainer device 65, which is constructed in accordance with an embodiment, and which includes a cord gripper in the form of a curved slot 66. The curved slot 66 is similar to the curved slot 21 of the device 10. The device 65 includes a pair of ornamental or decorative openings such as an opening 67 to provide the device 65 with a unique overall appearance. The outline of the device 65 is configured in the shape similar to the shape of a guitar.

Referring now to FIG. 9, a cord retainer device 69 is constructed in accordance with an embodiment and is generally configured in the shape of a guitar. The device 69 includes distinctive openings such as openings 71 and 72. Thus, the device 69 is another example of various embodiments of the cord retainer device may have different aesthetically pleasing appearances.

Referring now to FIGS. 14, 15 and 16, there is shown a cord retainer device 74, which is constructed according to hand embodiments. The device 74 is similar to the device one, except that the device 52 includes a gripper in the form of a hook 4. The device 52 includes an attachment device in the form of an opening 56 for attachment to a connector such as the strand 27. On the obverse side of the device 52, there is a raised image area 58 for decorative purposes such as bearing the logo or name of the user. The device 52 has an overall teardrop shaped or appearance.

Referring now to FIGS. 13-17, there is shown a cord retainer device 74, which is constructed in accordance with an embodiment, and which has a movable retainer arrangement. The device 74 includes a decorative teardrop shaped base plate 75 having an image area plate 76 on the front side thereof similar to the image area plate 58 of the device 52 for bearing a logo or other ornamental design. A hole 78 is adapted to be connected to a connector (not shown) such as strand 23. It should be understood that the connector for the cord retaining devices may also be a cord, leather strip, chain, strap or other flexible or rigid device.

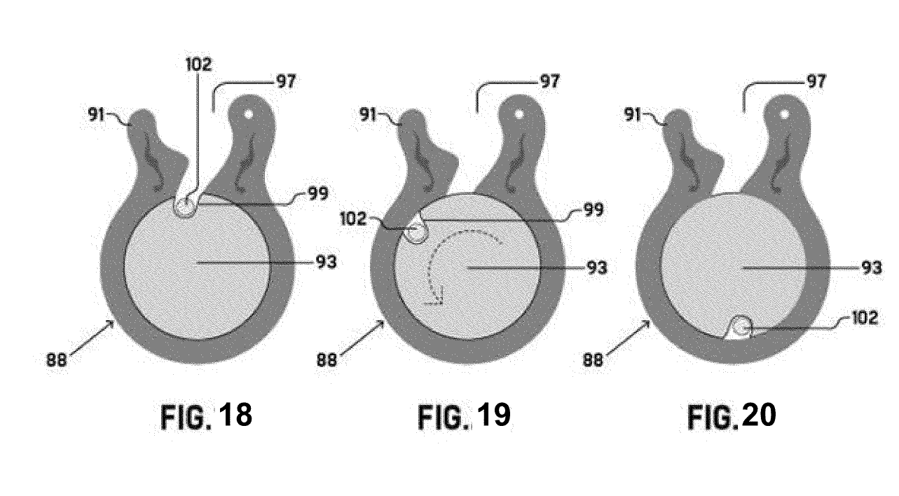

A generally L shaped movable gripper 77 releasably attaches a cord such as an electrical cord 79 to the device 74 and is mounted on the rear face of the plate 75. The gripper 77 is slidably mounted on the plate 75 to move manually adjustably with respect to a hook-shaped stationary bracket 82 for retaining the cord 79 therebetween. A pin 84 extends from the L shaped bracket 77 and is disposed and frictionally engaged within a slot 86 in the plate 75 to enable the movable gripper 77 to move vertically away from the stationary bracket 82 as shown in FIG. 18 for inserting the cord 79 between the gripper 77 and the stationary bracket 82. The gripper 77 may then be moved manually along the slot 86 into its closed position as indicated in FIG. 16.

Referring now to FIGS. 18-24, there is shown a cord retainer device 88, which is another embodiment for operation similar to the cord retainer device 10, and has a movable locking arrangement. The device 88 includes an outer partially circular member 91, which partially surrounds an inner rotatable circular disk 93. A semi-circular opening 95 in the outer member 91 may be disposed in alignment with an enlarged entrance opening portion 97 of the outer circular member 91 to be aligned with a semi-circular notch 99 in the periphery of the disk 93, whereby, as shown in FIG. 18, and electrical cord 102 can be received within the gap 97 and then disposed within the notch 99. Thereafter, as indicated in FIG. 19, the rotatable circular disk 93, may be rotated manually as indicated by the curved arrow to another location for carrying the electrical cord 102 therewith into a final locking position as illustrated in FIG. 20.

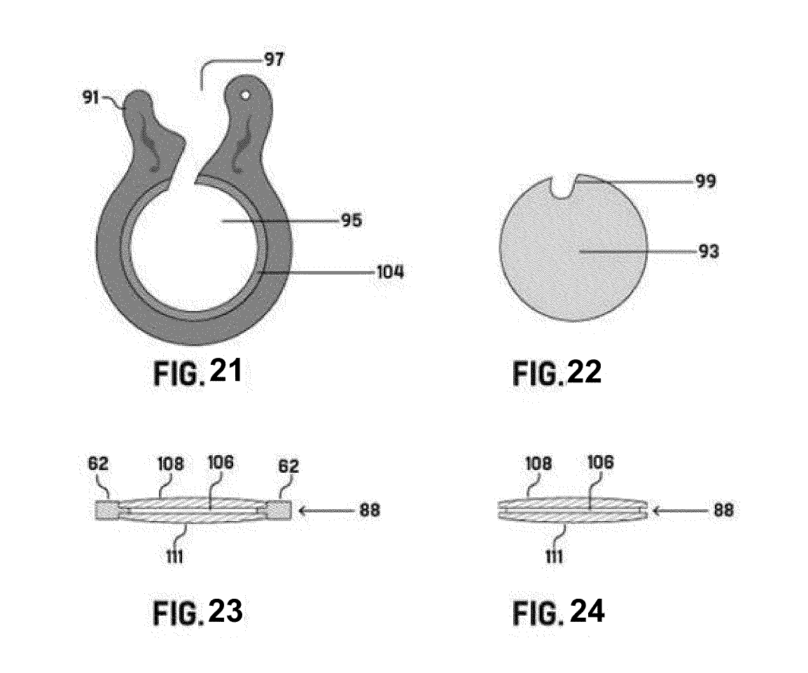

As shown in FIGS. 21-24, a peripheral rib 104 in the outer partially circular member 91 fits into a peripheral opening 106 in the rotatable disc 93 to enable it to rotate relative to the member 91. The disk 93 includes a pair of disk parts 108 and 111, which may be snapped together by suitable pin connections for securing the disk 93 within the opening 95 of the circular member 91.

Guitar straps are one of the most important ACCESSORIES FOR ANY GUITARIST. The guitar strap may have a uniquely integrated design that brings together a traditional strap with a functional purpose of holding the electric guitar cord in a position that prevents or at least inhibits it from being dislodged from the output jack (not shown) of the guitar. As shown in FIG. 5, the strap 41 extends integrally beyond the strap button hole (point A) to accommodate an additional slit opening 47 (point C) or device such as the device 32) that supports the electric cord. The extended strap feature (displayed at point B) means the guitarist no longer has to wrap the cord between the guitar and a traditional strap to fix its position and prevent the cord from dislodging from the output jack. The guitar strap 41 positions the electric cord further away from the guitarist's arm motion and body, enabling freer range of movement.

The cord retainer device 10 is an accessory designed to accommodate and retain musical instrument cords and cables connected to the guitar. Primarily used by an electric or bass guitar player the cord retainer device 10 allows him or her greater freedom to move with the instrument with the assurance that the cord connecting the guitar to the amplifier (not shown) will not be yanked out of the guitar socket (output jack not shown) when first taut.

The cord retainer device 10 connects to the guitar end pin such as the end pin 25 (the metal knob on the bottom end of the guitar body where the shoulder strap may be attached). The electrical cord is then slid onto the device 10 leaving a little slack between the device 10 and the guitar 14.

Musical instrument accessories can add color, style and class to a musician's persona. For guitarists, the most common conventional method of supporting the cord is to thread the cord between the guitar and the strap near the end pin.

The device 10 may help customize the guitar. The device 10 may be composed of custom guitar materials personalized or engraved with a message, band logo or artwork. The device 10 may be used to support the guitar cord or as a display pendant or ornament.

The device 10 may be made of acrylic material due to its strength and light weight. It is inert and hypoallergenic. The retainer member 18 of the device 10 may be constructed out of acrylic sheets, various plastics, wood, soft metals, PVC material, fiberglass or others. The material may be cut using a laser. The pieces may be attached to a chain via findings and to the guitar via a clasp.

While particular embodiments of the present invention have been disclosed, it is to be understood that various different modifications and combinations are possible and are contemplated within the true spirit and scope of the disclosed embodiments. There is no intention, therefore, of limitations to the exact disclosure herein presented.

What is claimed is:

1. A cord retainer device for a musical instrument having a cord, comprising:
a decorative retainer member having a gripper for attaching removably to the musical instrument cord;
a connector for attaching the member to the musical instrument; and
whereby the cord retainer device helps maintain the cord connected to the musical instrument.

2. A cord retainer device according to claim 1, wherein the retainer member is a decorative plate, and the gripper means defining a cord holding slot suitably dimensioned to secure the cord frictionally and removably, whereby the retainer device provides a locking tension between the cord end connected to the musical instrument and any tension applied to the opposite end of the cord.

3. A cord retainer device according to claim 1, wherein the attachment device includes a decorative strand secured detachably at one end to the musical instrument and secured at its other end to the retainer member.

4. A cord retainer device according to claim 1, further including a musical instrument strap for helping support the instrument from the user, the strap including an extension for receiving the device to attach the retainer device to the musical instrument.

5. A cord retainer device according to claim 1, wherein the connector includes a ring.

6. A cord retainer device according to claim 1, wherein the gripper includes a pin received frictionally within a slot.

7. A cord retainer device according to claim 1, wherein the gripper includes a hook.

8. A method of retaining a cord attached to a musical instrument, using a cord retainer device as specified in claim 1, including inserting the musical instrument cord releasably within the retainer.

9. A cord retainer device according to claim 2, the slot is an S shaped slot having an enlarged entrance opening at one and an opposite end.
